(19) United States
(12) Patent Application Publication
(10) Pub. No.: US 2009/0063907 A1
(43) Pub. Date: Mar. 5, 2009

(54) DEBUGGING SYSTEM, DEBUGGING APPARATUS AND METHOD

(75) Inventors: Nobuhiro TSUBOI, Osaka (JP); Atsushi UBUKATA, Kyoto (JP); Tomohisa SEZAKI, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/199,054

(22) Filed: Aug. 27, 2008

(30) Foreign Application Priority Data
Aug. 29, 2007 (JP) 2007-223285

(51) Int. Cl. G06F 11/36; G06F 12/00; G06F 11/07

(52) U.S. Cl. 714/48; 717/129; 711/118; 711/154; 717/127; 714/E11.024; 711/E12.001

(57) ABSTRACT

A debugging system which can efficiently obtain debugging information and which has excellent debugging efficiency is a debugging system which stops execution of a program executed in a program executing apparatus, at a break point, and assists debugging of the program, and which includes: a dump control unit configured to dump information indicating an operating state of the program executing apparatus, at plural points in time prior to the stopping of the execution of the program; and a dump information accumulating unit configured to accumulate the information indicating the operating state of the program executing apparatus dumped by said dump control unit.

### BACKGROUND OF THE INVENTION

(1) Field of the Invention

The present invention relates to debugging systems and methods, and particularly to a debugging system and method for stopping execution of a program to be executed in a program executing apparatus, at a breakpoint, and assisting debugging of the program.

(2) Description of the Related Art

A debugging apparatus that causes the temporary stopping of the execution of a program in a processor, and displays the execution state of the program is useful in program development. The debugging apparatus assists the finding and correction, that is, the debugging, of a program defect (bug) which is an operating error in the program. Furthermore, various debugging apparatuses are proposed in order to improve debugging efficiency (for example, Patent Reference 1: Japanese Unexamined Patent Application Publication No. 5-250208).

With the debugging apparatus in the aforementioned Patent Reference 1, in the case where it is necessary to interrupt operation during debugging, it is possible to save the state of debugging at the time of interruption in an external storage device and, subsequently, return to the state of debugging at the time when the debugging was stopped.

In addition, there is proposed a debugging apparatus that can check the flow of execution of a program by causing the program counter history during debugging to be temporarily stored in a trace memory, and then subsequently saved in an external storage device.

### SUMMARY OF THE INVENTION

However, according to the above-described prior art, in order to check the flow of the execution of a program in a processor, each time, a debugging technician needs to set an appropriate trigger condition to the debugging apparatus and obtain information required for debugging (hereafter called debugging information) such as the history of a program counter, for example. In order to obtain the debugging information, it is necessary for the debugging technician to set a trigger condition repeatedly and repeat the obtainment of debugging information, and thus debugging efficiency is poor.

The present invention is conceived in view of the aforementioned problem and has as an object to provide a debugging system and method capable of efficiently obtaining debugging information, and having good debugging efficiency.

In order to achieve the aforementioned object, the debugging system according to the present invention is debugging system which stops execution of a program executed in a program executing apparatus, at a breakpoint, and assists debugging of the program, the debugging system includes: a dump control unit which dumps information indicating an operating state of the program executing apparatus, at plural points in time prior to the stopping of the execution of the program; and a dump information accumulating unit which accumulates the information indicating the operating state of the program executing apparatus dumped by the dump control unit.

With this configuration, in the one program execution in which the execution of the program is stopped, it is possible to obtain, as debugging information, information indicating the operating state of the program executing apparatus at plural times during program execution. Accordingly, it becomes possible to implement a debugging system capable of efficiently obtaining debugging information, and having good debugging efficiency.

Furthermore, the information indicating the operating state of the program executing apparatus may include contents of a stack region of a memory, and the dump control unit may dump, at the plural points in time, the contents of the stack region of the memory.

With this configuration, it becomes possible to output the contents of the stack region at plural points in time during program execution. In other words, in the one program execution up to the stopping of the execution of the program, it is possible to obtain stack region contents along the time-series as debugging information. With this, debugging information can be obtained efficiently.

Furthermore, the information indicating the operating state of the program executing apparatus may include either information indicating a state of a Central Processing Unit (CPU) or error information detected by the CPU, stored in a system register of the CPU, and the dump control unit may dump, at the plural points in time, the information indicating either the state of the CPU or the error information detected by the CPU.

With this configuration, it becomes possible to output information indicating the state of the CPU or error information detected by the CPU at plural points in time during program execution. In other words, in the one program execution in which the execution of the program is stopped, it is possible to obtain, as debugging information, information indicating the state of the CPU or error information detected by the CPU, along the time-series. Therefore, in the case where plural errors occur, it becomes possible to check, all at once, the sequence of the errors and the state of the CPU at the time each error occurred. With this, debugging information can be obtained efficiently.

Furthermore, the information indicating the operating state of the program executing apparatus may include contents of either a cache memory or a Translation Look-aside Buffer (TLB), and the dump control unit may dump, at the plural points in time, the contents of either the cache memory or an entry of the TLB.

With this configuration, it becomes possible to output the contents of the cache memory or TLB entry at plural points in time during program execution. In other words, in the one program execution in which the execution of the program is stopped, the contents of the cache memory or the TLB entry can be obtained along the time-series, as debugging information. Since the usage of the cache memory or the TLB entry along the time-series of the program execution can be checked all at once as debugging information, debugging information can be obtained efficiently.

Furthermore, the information indicating the operating state of the program executing apparatus may include contents of at least one of a memory, a system register of a CPU, a cache memory, and a TLB.

With this configuration, in the one program execution in which the execution of the program is stopped, at least one of information indicating the state of the CPU or error information detected by the CPU, the contents of the cache memory, and the contents of the TLB entry, can be obtained as debugging information, along the time-series. Therefore, debugging information can be obtained efficiently.

Furthermore, the debugging system may further include a trigger signal generating unit which generates a trigger signal at the plural points in time, wherein the dump control unit may dump the information indicating the operating state of the program executing apparatus, when the trigger signal is generated.

With this configuration, it is possible to obtain, as debugging information, information indicating the operating state of the program executing apparatus, when a trigger signal is generated. With this, it is possible to obtain, along the time-series, debugging information at the time of the occurrence of a required event such as the occurrence of cache thrashing, for example.

Furthermore, the debugging system may further include a cache thrashing detecting unit which detects an occurrence of thrashing in the cache memory, wherein the trigger signal generating unit may generate the trigger signal when the cache thrashing detecting unit detects the occurrence of thrashing in the cache memory.

With this, it is possible to obtain, as debugging information, information on when cache thrashing leading to performance deterioration occurs, and the operating state of the program executing apparatus at such point in time.

Furthermore, the debugging system may further include a TLB thrashing detecting unit which detects an occurrence of thrashing in the TLB, wherein the trigger signal generating unit may generate the trigger signal when the TLB thrashing detecting unit detects the occurrence of thrashing in the TLB.

With this, it is possible to obtain, as debugging information, information on when TLB thrashing leading to performance deterioration occurs, and the operating state of the program executing apparatus at such point in time.

Furthermore, the debugging system may further include a specified command detecting unit which detects that a currently executed command is a specified command, wherein the trigger signal generating unit may generate the trigger signal when the specified command detecting unit detects that the currently executed command is the specified command.

With this, it is possible to obtain, as debugging information, the operating state of the program executing apparatus at the point in time when a specified command is executed. In addition, by restricting the timing for dumping to the point in time at which the specified command is executed, reduction of the capacity of the dump information accumulating unit becomes possible.

Furthermore, the debugging system may further include a within-specified-range detecting unit which detects that a value of a program counter in the program executing apparatus is within a specified range, wherein the trigger signal generating unit may generate the trigger signal when the within-specified-range detecting unit detects that the value of the program counter in the program executing apparatus is within the specified range.

With this, it is possible to obtain, as debugging information, the operating state of the program executing apparatus at the point when the value of a specified program counter is within a specified range. In addition, by restricting the timing for dumping to the point in time when the value of a specified program counter is within a specified range, reduction of the capacity of the dump information accumulating unit becomes possible.

Furthermore, the debugging system may further include a loop iteration detecting unit which detects an iteration of a specified loop, wherein the trigger signal generating unit may generate the trigger signal when the loop iteration detecting unit detects the iteration of the specified loop.

With this, even in the case where the iteration of a specified loop continues and the currently executed program goes into error, it becomes possible to obtain the operating state of the program executing apparatus as necessary debugging information.

Furthermore, the debugging system may further include an interrupt signal detecting unit which detects a specified interrupt signal, wherein the trigger signal generating unit may generate the trigger signal when the interrupt signal detecting unit detects the specified interrupt signal.

With this, it is possible to obtain, as debugging information, the operating state of the program executing apparatus at the point in time when a specified interrupt occurs and before the interrupt is detected by the CPU.

Furthermore, the debugging system may further include a bus malfunction detecting unit which detects malfunctioning of a bus, wherein the trigger signal generating unit may generate the trigger signal when the bus malfunction detecting unit detects the malfunctioning of the bus.

With this, it is possible to obtain, as debugging information, the operating state of the program executing apparatus at the point in time when malfunctioning of a bus is detected and before the malfunctioning of the bus is detected by the CPU.

Furthermore, the debugging system may further include a specified command detecting unit which detects that a currently executed command is a specified command; a within-specified-range detecting unit which detects that a value of a program counter in the program executing apparatus is within a specified range; a loop iteration detecting unit which detects an iteration of a specified loop; an interrupt signal detecting unit which detects a specified interrupt signal; a bus malfunction detecting unit which detects malfunctioning of a bus; and an accepting unit which accepts a user operation, wherein the trigger signal generating unit may (i) select or not-select, based on the user operation accepted by the accepting unit, each of: a detection result of the specified command detecting unit; a detection result of the within-specified-range detecting unit; a detection result of the loop iteration detecting unit; a detection result of the interrupt signal detecting unit; and a detection result of the bus malfunction detecting unit, and (ii) generate the trigger signal when the specified command detecting unit, the within-specified-range detecting unit, the loop iteration detecting unit, the interrupt signal detecting unit, and the bus malfunction detecting unit, corresponding to the selected detection result detects the respective detection result.

With this, based on a user operation, it is possible to obtain, as debugging information, information indicating the operating state of the program executing apparatus at the time of the occurrence of a required event preferred by the user, such as the occurrence of cache thrashing, for example.

Furthermore, the debugging system may further include a nonvolatile memory; a nonvolatile memory control unit which controls writing into the nonvolatile memory; and a cut-off control unit which cuts-off power supply to the dump control unit and the dump information accumulating unit, wherein the nonvolatile memory control unit may write, into the nonvolatile memory, the information indicating the operating state of the program executing apparatus accumulated in the dump information accumulating unit, the dump control unit may output a signal for causing termination of an operation, to the termination control unit, after the information indicating the operating state of the program executing apparatus is written into the nonvolatile memory, and the termination control unit may cut-off the power supply to the dump control unit and the dump information accumulating unit, after the nonvolatile memory control unit writes the information into the nonvolatile memory.

With this, even when the power supply to the debugging system is cut-off after obtaining the information indicating the operating state of the program executing apparatus as debugging information, it is possible to save the obtained debugging information.

Note that the present invention can be implemented, not only as an apparatus, but also as an integrated circuit including the processing units included in such an apparatus, and as a method having, as steps, the processing units included in such apparatus.

With the present invention, it is possible to implement a debugging system and method capable of efficiently obtaining debugging information, and having good debugging efficiency.

### FURTHER INFORMATION ABOUT TECHNICAL BACKGROUND TO THIS APPLICATION

The disclosure of Japanese Patent Application No. 2007-223285 filed on Aug. 29, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing an external view of the program debugging system 1 in an embodiment of the present invention;

FIG. 2 is a diagram showing an external view of the program debugging system 5 in an embodiment of the present invention;

FIG. 3 is block diagram showing the configuration of a debugging system in an embodiment of the present invention;

FIG. 4 is a block diagram showing the configuration of a debug control circuit in an embodiment of the present invention;

FIG. 5 is a flowchart describing the dumping process of the debugging system in an embodiment of the present invention;

FIG. 6 is a flowchart describing the process of determining a trigger signal in an embodiment of the present invention;

FIG. 7 is a flowchart describing the process in displaying debugging information in an embodiment of the present invention; and

FIG. 8 is a diagram showing, as an example, a circuit substrate 202 of an embedded system using a debugging CPU which is a debug target that can use the debugging system 100.

### DESCRIPTION OF THE PREFERRED EMBODIMENT(S)

Hereinafter, an embodiment of the present invention shall be described with reference to the Drawings.

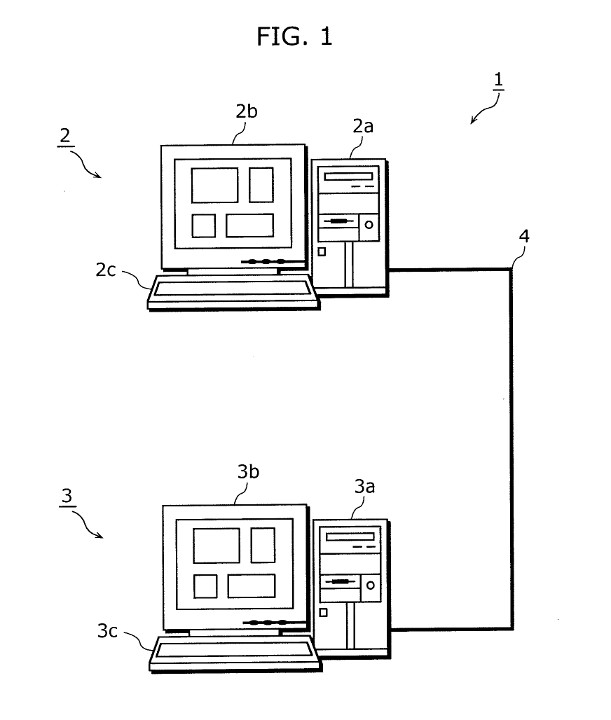

FIG. 1 is a diagram showing an external view of the program debugging system in the embodiment of the present invention. A program debugging system 1 in FIG. 1 includes a program debugging apparatus 2 and a program executing apparatus 3.

The program debugging apparatus 2 includes a main device 2a, a display device 2b, and an input device 2c. The main device 2a is a device which: receives various operating instructions from a debugging technician via the input device 2c; controls the execution of a debug target program in the program executing apparatus 3; and displays debugging information specified in advance by the debugging technician, through the display device 2b.

In the program debugging apparatus 2, a trigger condition corresponding to debugging information needed for the debugging operation is set by the debugging technician, before the debug target program is executed in the program executing apparatus 3. Here, debugging information refers to, for example, the history of a program counter, the return address or argument of a function to be executed, the contents of a stack region such as a local variable in a context, and an output of information indicating the state of the CPU or error information detected by the CPU, and so on.

The program executing apparatus 3 is a data processing device which executes simulation software that simulates the operation of a processor (or an evaluation board including a processor) executing the debug target program. The program executing apparatus 3 includes a main device 3a, a display device 3b, and an input device 3c, and is controlled from the program debugging apparatus 2 via a LAN cable 4. The program executing apparatus 3 can act as a substitute in the case where a target system is in the design stage and still does not exist.

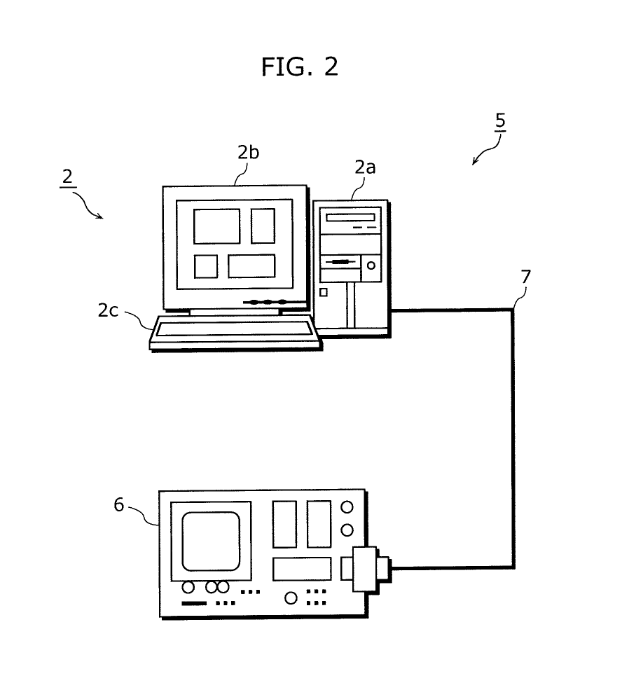

FIG. 2 is a diagram showing an external view of another program debugging system 5. The program debugging system 5 in the same diagram is different compared to FIG. 1 in including a program executing apparatus 6 instead of the program executing apparatus 3. The program executing apparatus 6 is a processor or an evaluation board including a processor, and is controlled from the program debugging apparatus 2 via a connecting cable 7.

The program debugging apparatus 2 essentially operates in the same manner in the case where it is connected to the program executing apparatus 3 which is a program simulator as in FIG. 1, or in the case where it is connected to the program executing apparatus 6 which is a processor (or evaluation board) as in FIG. 2.

Further, the aforementioned simulation software may be executed on the computer of the program debugging apparatus 2, and furthermore, the program debugging apparatus 2 may include the functions of the program executing apparatus 3.

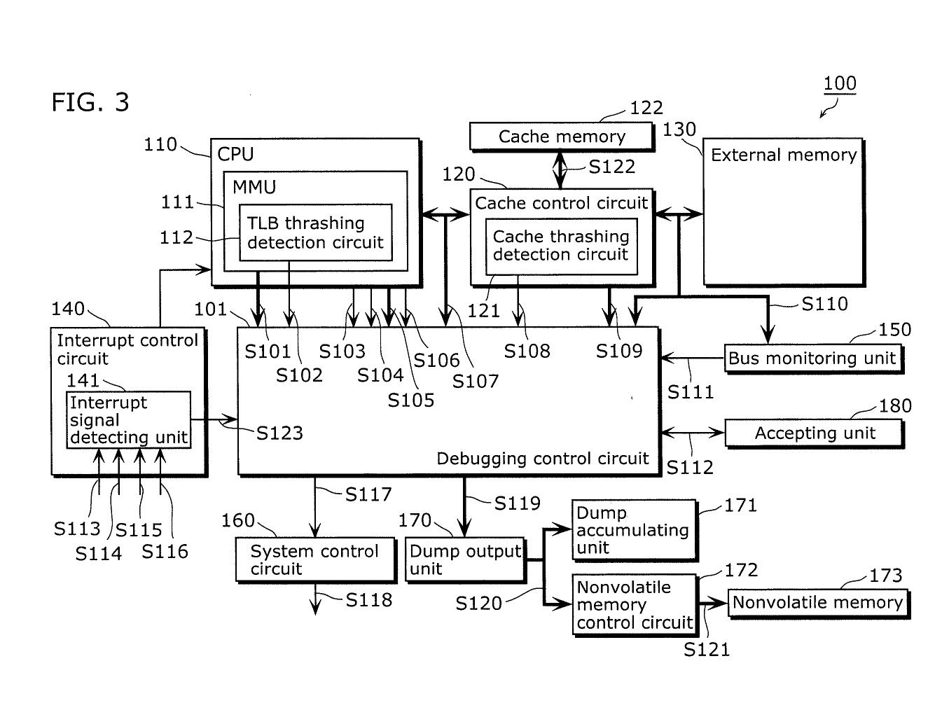

FIG. 3 is a block diagram showing the configuration of a debugging system in an embodiment of the present invention.

In FIG. 3, a debugging system 100 is a debugging system which stops the execution of a program to be executed in a program executing apparatus, at a breakpoint, and assists the debugging of the program. The debugging system 100 includes a debugging control circuit 101, a Central Processing Unit (CPU) 110, a Memory Management Unit (MMU) 111, a Translation Look-aside Buffer (TLB) thrashing detection circuit 112, a cache control circuit 120, a cache thrashing detection circuit 121, a cache memory 122, an external memory 130, a interrupt control circuit 140, an interrupt signal detecting unit 141, a bus monitoring circuit 150, a system control circuit 160, a dump output unit 170, a dump accumulating unit 171, a nonvolatile memory control circuit 172, a nonvolatile memory 173, and an accepting unit 180.

Here, the CPU 110, the MMU 111, the TLB thrashing detection circuit 112, the cache control circuit 120, the cache thrashing detection circuit 121, the cache memory 122, the external memory 130, and the bus monitoring circuit 150 configure the program executing apparatus 3 or the program executing apparatus 6 shown in FIG. 1 or FIG. 2, respectively.

The CPU 110 internally includes the MMU 111, and registers (not illustrated) which are storage elements used in storing calculation and execution states. The CPU 110 executes a debug target program stored in the external memory 130. During the execution of the debug target program, the CPU 110 sends a program counter value, a stack pointer value, a system register value, and information of a command to be executed, to the debugging control circuit 101, via a signal line S103, a signal line S104, a bus S105, and a signal line S106, respectively.

The MMU 111 is included inside the CPU 110 and assigns a physical memory space to a virtual memory space. During the execution of the debug target program, the MMU 111 sends the contents of a TLB entry to the debugging control circuit 101, via a bus S101.

The TLB thrashing detection circuit 112, which corresponds to the TLB thrashing detecting unit in the present invention, detects the occurrence of thrashing in a Transition Look-aside Buffer (TLB). Specifically, the TLB thrashing detection circuit 112 is configured within the MMU 111 and, upon detecting thrashing in the TLB, sends a TLB thrashing detection signal indicating the detection of thrashing in the TLB, to the debugging control circuit 101 via a signal line S102.

Here, TLB thrashing refers to a state in which, when the range within which the TLB can map a memory at one time is exceeded, paging occurs frequently and the program controlling the TLB occupies a majority of the CPU 110, and the system as a whole is unable to carry out its functions.

The cache memory 122 accumulates data stored in the external memory 130 that is frequently used by the CPU 110, and assists the speed-up of processing by the CPU 110, by reducing access to the low-speed external memory 130. The cache memory 122 exchanges data with the external memory 130 via a bus S122.

The cache control circuit 120 carries out the exchange of data between the CPU 110 and the cache memory 122 and external memory 130, via a bus S107. Furthermore, the cache control circuit 120 exchanges data with the external memory 130 via a bus S110. The cache control circuit 120 exchanges data with the cache memory 122 via a bus S122. Furthermore, the cache control circuit 120 sends an entry indicating the contents of the cache memory 122, to the debugging control circuit 101 via a bus S109.

The cache thrashing detection circuit 121, which corresponds to the cache thrashing detecting unit in the present invention, detects the occurrence of thrashing in the cache memory 122. Specifically, upon detecting thrashing in the cache memory 122, the cache thrashing detection circuit 121 sends a cache thrashing detection signal to the debugging control circuit 101 via a signal line S108.

Here, cache thrashing refers to a state in which, when the storage space of the cache memory 122 is insufficient, referencing occurs frequently and the program controlling the cache memory 122 occupies a majority of the CPU 110, and the system as a whole is unable to carry out its functions.

The external memory 130 is connected to the cache control circuit 120 via the bus S110, and exchanges data with the cache control circuit 120 via the bus S110. Furthermore, the external memory 130 sends the contents of a stack region in the memory to the debugging control circuit 101 via the bus S110, in response to a request from the debugging control circuit 101.

Here, the contents of a stack region in the memory include information indicating, for example, the return address of a function to be executed, an argument, the local variable in a context, and so on.

The bus monitoring circuit 150, which corresponds to the bus malfunction detecting unit in the present invention, detects malfunctioning of the bus. Specifically, the bus monitoring circuit 150 monitors the state of the bus S110, judges that the bus is malfunctioning in the case where a predetermined condition is satisfied, and sends a signal indicating that the bus is malfunctioning, to the debugging control circuit 101 via a signal line S111.

Here, the case where a predetermined condition is satisfied refers to, for example, respective cases where various bus errors occur.

When an interrupt signal is inputted, the interrupt control circuit 140 performs control to activate an interrupt program and resume the original program after the execution of the interrupt program. The interrupt control circuit 140 has a role of forwarding, to the CPU 110, interrupt signals received via a signal line S113, a signal line S114, a signal line S115, and a signal line S116.

The interrupt signal detecting unit 141, which corresponds to the interrupt signal detecting unit in the present invention, detects a specified interrupt signal. Specifically, the interrupt signal detecting unit 141 is included in the interrupt control circuit 140, and transmits a specified interrupt signal to the debugging control circuit 101 via the signal line S123, in the case where an interrupt signal received via the signal lines S113, S114, S115, and S116 is a predetermined condition. Here, a predetermined condition is a condition such as, for example, when a value of an interrupt level indicating the priority of an interrupt process is equal to or greater than a certain value.

The debugging control circuit 101 dumps, to the dump output unit 170, information indicating the operating state of the program executing apparatus 3 or 6, at plural points in time prior to the stopping of the execution of a debug target program.

Here, the information indicating the operating state of the program executing apparatus 3 or 6 is, for example, at least one of the following (1) to (4) contents. (1) Contents of a stack region of the external memory 130 in which the return address of a function to be executed, an argument, a local variable, and so on are stored; (2) information of a system register in which the state of the CPU 110 or error information detected by the CPU 110 is stored; (3) contents of an entry in the cache memory 122; and (4) contents of an entry in the TLB.

The accepting unit 180 accepts a user operation and instructs the debugging control circuit 101. Following the user's instruction, the accepting unit 180 sets to valid or invalid the settings of flag registers of a trigger signal generating unit 102, by instructing the debugging control circuit 101. When a flag register setting of the trigger signal generating unit 102 is set to valid, the detection result signal corresponding to the valid flag register is selected. The trigger signal generating unit 102 generates a trigger signal at the point in time when the selected detection result signal is inputted.

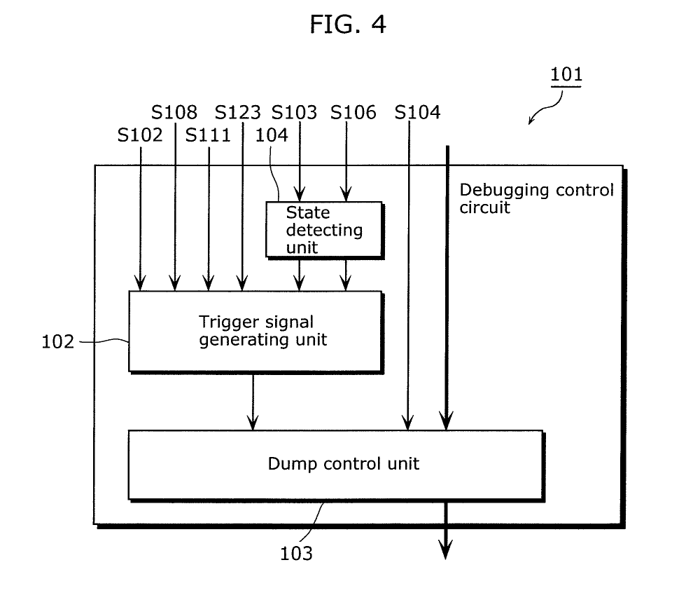

FIG. 4 is a block diagram showing the configuration of the debugging control circuit 101 in the embodiment of the present invention.

The debugging control circuit 101, as shown in FIG. 4, includes the trigger signal generating unit 102, a state detecting unit 104, and a dump control unit 103.

When the trigger signal generating unit 102 generates a trigger signal, the debugging control circuit 101 dumps, through the dump control unit 103, the information indicating the operating state of the program executing apparatus 3 or 6, and outputs the information to the dump output unit 170.

The state detecting unit 104 corresponds to the specified command detection unit, within-specified-range detecting unit, and loop iteration detecting unit in the present invention.

The state detecting unit 104 detects whether the currently executed command is the specified command. Specifically, information of the executed command is inputted from the CPU 110 via the signal line S106, and the state detecting unit 104 detects whether or not the inputted information is the specified command. Upon detecting that the command currently being executed in the CPU 110 is the specified command, the state detecting unit 104 outputs, to the trigger signal generating unit 102, a detection result signal indicating that the command being executed is the specified command.

Furthermore, the state detecting unit 104 detects whether the value of the program counter is within a specified range. Specifically, the program counter value is inputted from the CPU 110 via the signal line S103, and the state detecting unit 104 detects whether or not the inputted program counter value is within the specified range. Upon detecting that the program counter value in the CPU 110 is within the specified range, the state detecting unit 104 outputs, to the trigger signal generating unit 102, a detection result signal indicating that the program counter value is within the specified range.

Furthermore, the state detecting unit 104 monitors the value of the program counter and detects the occurrence of a specified loop iteration. Specifically, the program counter value is inputted from the CPU 110 via the signal line S103, and the state detecting unit 104 detects, based on the inputted program counter value, whether or not the specified loop iteration occurs. When the state detecting unit 104 detects the occurrence of the specified loop iteration based on the program counter value, it outputs, to the trigger signal generating unit 102, a detection result signal indicating the detection of the specified loop iteration.

The trigger signal generating unit 102, which corresponds to the trigger signal generating unit in the present invention, generates a trigger signal at plural points in time.

In the case where the detection result signal corresponding to the valid flag register is a detection result signal from the state detecting unit 104, the trigger signal generating unit 102 generates a trigger signal at the point in time when the detection result signal is inputted from the state detecting unit 104.

Furthermore, in the case where the detection result signal corresponding to the valid flag register is a detection result signal from the TLB thrashing detection circuit 112, the trigger signal generating unit 102 generates a trigger signal at the point in time when the detection result signal indicating the detection of TLB thrashing is inputted from the TLB thrashing detection circuit 112 via the signal line S102.

Furthermore, in the case where the detection result signal corresponding to the valid flag register is a detection result signal from the cache thrashing detection circuit 121, the trigger signal generating unit 102 generates a trigger signal at the point in time when the detection result signal indicating the detection of cache thrashing is inputted by the cache thrashing detection circuit 121 via the signal line S108.

Furthermore, in the case where the detection result signal corresponding to the valid flag register is a detection result signal from the interrupt signal detecting unit 141, the trigger signal generating unit 102 generates a trigger signal at the point in time when the detection result signal indicating the detection of a specified interrupt signal is inputted by the interrupt signal detecting unit 141 via the signal line S123.

Furthermore, in the case where the detection result signal corresponding to the valid flag register is a detection result signal from the bus monitoring circuit 150, the trigger signal generating unit 102 generates a trigger signal at the point in time when the detection result signal indicating that the bus is malfunctioning is inputted from the bus monitoring circuit 150 via the signal line S111.

At the point in time when the trigger signal generating unit 102 generates the trigger signal, the dump control unit 103 dumps information specified in advance by a user, for example, the debugging technician, among the information (1) to (4) indicating the operating state of the program executing apparatus 3 or 6, and outputs the information to the dump output unit 170.

Furthermore, in accordance with a user instruction via the accepting unit 180, the dump control unit 103 can select at least one or more of: the contents of the stack region of the external memory 130; the information of the system register in which the state of the CPU 110 or error information detected by the CPU 110 are stored; the contents of an entry in the cache memory 122; and the contents of an entry in the TLB, and adopt the selected information as the information (hereafter called dump information) indicating the operating state of the program executing apparatus 3 or 6, to be outputted to the dump output unit 170.

A stack pointer value is inputted to the dump control unit 103, from the CPU 110 via the signal line S104. In the case of dumping the contents of the stack region of the external memory 130 as the dump information, the dump control unit 103 identifies, with the inputted stack pointer value, the position of the stack to be dumped and dumps the contents of the stack region of the external memory 130, at the point in time when the trigger signal generating unit 102 generates the trigger signal. In other words, the dump control unit 130 outputs the contents of the stack region of the external memory 130 to the dump output unit 170.

Furthermore, the contents of the TLB entry is inputted to the dump control unit 103, from the MMU 111 via the bus S101. In the case of dumping the entry contents of the TLB as the dump information, the dump control unit 103 dumps the entry contents of the TLB, at the point in time when the trigger signal generating unit 102 generates the trigger signal. In other words, the dump control unit 130 outputs the contents of the entry of the TLB to the dump output unit 170.

Furthermore, the contents of the cache entry are inputted to the dump control unit 103, from the cache control circuit 120 via the bus S109. In the case of dumping the contents of the cache entry as the dump information, the dump control unit 103 dumps the contents of the cache entry, at the point in time when the trigger signal generating unit 102 generates the trigger signal. In other words, the dump control unit 130 outputs the contents of the cache entry to the dump output unit 170.

Furthermore, in accordance with a user instruction via the accepting unit 180, the dump control unit 103 controls the trigger generating unit 102 and sets to valid or invalid the settings of the flag registers of the trigger signal generating unit 102. By setting a flag register of the trigger signal generating unit 102 to valid, it is possible to select the trigger signal generated by the trigger signal generating unit 102 corresponding to the valid flag register.

In addition, the dump control unit 103 sends, to the system control circuit 160 via signal line S117, a cut-off instruction signal indicating the cutting-off of power supply to the debug system, such as to the dump control unit 103 and the dump accumulating unit 171, for example.

The system control circuit 160, which corresponds to the cut-off control unit in the present invention, cuts-off the power supply to the dump control unit and the dump information accumulating unit. Specifically, when a cut-off instruction signal indicating the cutting-off of the power supply to a debug system, such as to the dump control unit 103 and the dump accumulating unit 171, is inputted from the dump control unit 103 via the signal line S117, the system control circuit 160 sends, via signal line S118, a system termination signal to a debug system specified in advance such as the dump accumulating unit 171, for example.

Dump information is inputted to the dump output unit 170, from the dump control unit 103 in the debugging control circuit 101, via a bus S119. The dump output unit 170 sends the inputted dump information to the dump accumulating unit 171 or the nonvolatile memory control circuit 172, via a bus S120.

The dump accumulating unit 171, which corresponds to the dump information accumulating unit in the present invention, accumulates information indicating the operating state of the program executing apparatus which was dumped by the dump control unit. Specifically, the dump accumulating unit 171 accumulates the dump information outputted from the dump output unit 170.

The nonvolatile memory control circuit 172, which corresponds to the nonvolatile memory control unit in the present invention, controls writing in to the nonvolatile memory 173. Specifically, the nonvolatile memory control circuit 172 writes, as data, the dump information inputted from the dump output unit 170, into the nonvolatile memory 173 via a bus S121.

Next, the processing in the debugging system in the present invention shall hereinafter be described.

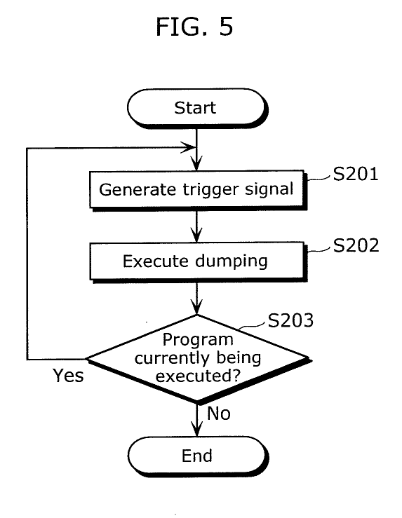

FIG. 5 is a flowchart describing the dumping process of the debugging system in the embodiment of the present invention.

First, the event for causing the generation of a trigger signal is specified by a user operation, to the accepting unit 180. Here, an event refers to: when the command to be executed is a specified command; when the program counter value is within a specified range; a specified iteration; thrashing in the TLB; cache thrashing; the input of a specified interrupt signal; and a malfunctioning of a bus.

Next, the trigger signal generating unit 102 is set, by the dump setting unit 103, to generate a trigger signal at the point in time when an event instructed by the accepting unit 180 is detected.

Next, upon detecting the event instructed by the accepting unit 180, the trigger signal generating unit 102 generates a trigger signal (S201).

In other words, the trigger signal generating unit 102 generates a trigger signal at the point in time when the state detecting unit 104, the TLB thrashing detection circuit 112, the cache thrashing detection circuit 121, the interrupt signal detecting unit 141, and the bus monitoring circuit 150 detects an event and inputs a signal indicating the detection of the event to the trigger signal generating unit 102.

Next, the dump control unit 103 executes dumping at the point in time when the trigger signal generating unit 102 generates a trigger signal (S202). In other words, the dump control unit 103 dumps the dump information and outputs it to the dump output unit 170, at the point in time when the trigger signal generating unit 102 generates a trigger signal. The dump output unit 170 outputs the inputted dump information, for example, to the dump accumulating unit 171.

Next, the dump control unit 103 judges whether or not the debug target program is currently being executed (S203). In the case where the debug target program is currently being executed (Yes in S203), the dump control unit 103 executes dumping at the point in time when the trigger signal generating unit 102 generates a trigger signal.

Note that, in the case where the debug target program is not currently being executed (No in S203), in other words, in the case where the debug target program is stopped at the breakpoint, the dump control unit 103 keeps the dumping process terminated.

Thus, the debugging system 100 performs the dump process as described above.

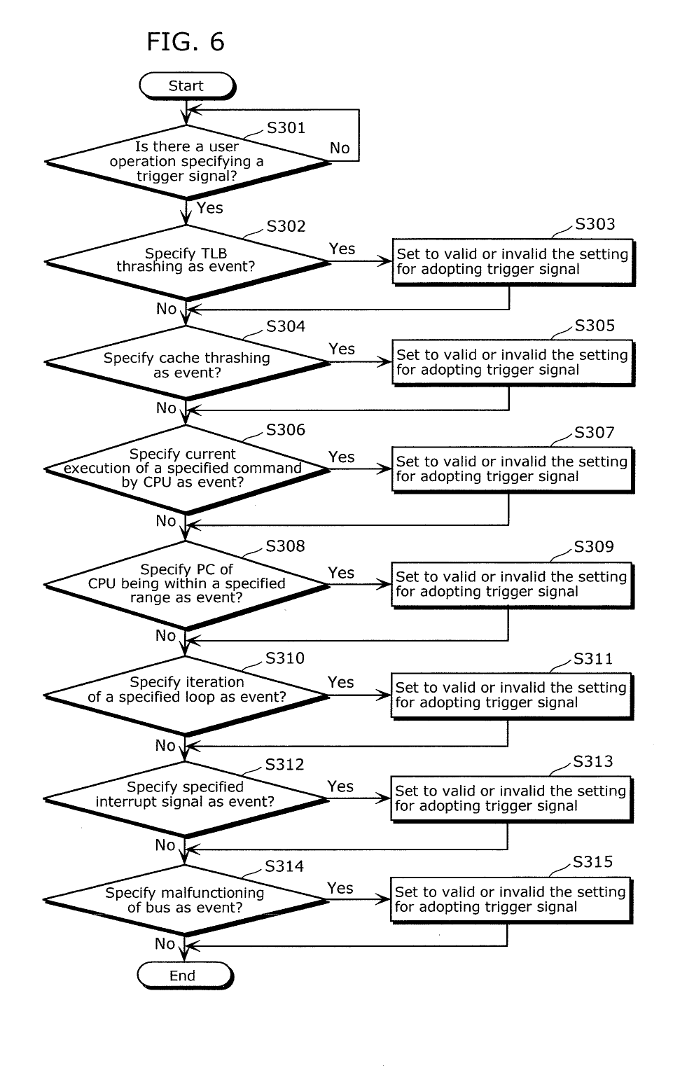

FIG. 6 is a flowchart describing the process of determining a trigger signal in the embodiment of the present invention.

First, the dump control unit 103 checks with the accepting unit 180 whether or not there is a user operation specifying a trigger signal (S301).

Next, the dump control unit 103 checks with the accepting unit 180 whether or not there is an instruction to specify TLB thrashing as an event (S302). In the case where there is, in the accepting unit 180, an instruction for specifying the TLB thrashing as an event (Yes in S302), the dump control unit 103 sets the trigger signal generating unit 102 to generate a trigger signal at the point in time when the event of TLB thrashing is detected. In other words, by setting the register flag of the trigger signal generating unit 102 corresponding to the event of TLB thrashing, the dump control unit 103 sets to valid or invalid the setting for adopting the detection of TLB thrashing as the trigger signal (S303).

Next, the dump control unit 103 checks with the accepting unit 180 whether or not there is an instruction to specify cache thrashing as an event (S304). In the case where there is, in the accepting unit 180, an instruction for specifying cache thrashing as an event (Yes in S304), the dump control unit 103 sets the trigger signal generating unit 102 to generate a trigger signal at the point in time when the event of cache thrashing is detected. In other words, by setting the register flag of the trigger signal generating unit 102 corresponding to the event of cache thrashing, the dump control unit 103 sets to valid or invalid the setting for adopting the detection of cache thrashing as the trigger signal (S305).

Next, the dump control unit 103 checks with the accepting unit 180 whether or not there is an instruction to specify, as an event, the event of the CPU 110 currently executing a specified command (S306). In the case where there is, in the accepting unit 180, an instruction for specifying the event of the CPU 110 currently executing a specified command as an event (Yes in S306), the dump control unit 103 sets the trigger signal generating unit 102 to generate a trigger signal at the point in time when the event in which the CPU 110 is currently executing a specified command is detected. In other words, by setting the register flag of the trigger signal generating unit 102 corresponding to the event in which the CPU 110 is currently executing a specified command, the dump control unit 103 sets to valid or invalid the setting for adopting the detection of the CPU 110 currently executing a specified command as the trigger signal (S307).

Next, the dump control unit 103 checks with the accepting unit 180 whether or not there is an instruction to specify, as an event, the event in which the program counter (hereafter called PC) of the CPU 110 is within a specified range (S308). In the case where there is, in the accepting unit 180, an instruction for specifying the event in which the PC of the CPU 110 is within a specified range as an event (Yes in S308), the dump control unit 103 sets the trigger signal generating unit 102 to generate a trigger signal at the point in time when the event in which the PC of the CPU 110 is within a specified range is detected. In other words, by setting the register flag of the trigger signal generating unit 102 corresponding to the event in which the PC of the CPU 110 is within a specified range, the dump control unit 103 sets to valid or invalid the setting for adopting the detection of the PC of the CPU being within a specified range as the trigger signal (S309).

Next, the dump control unit 103 checks with the accepting unit 180 whether or not there is an instruction to specify the specified loop iteration as an event (S310). In the case where there is, in the accepting unit 180, an instruction for specifying the specified loop iteration as an event (Yes in S310), the dump control unit 103 sets the trigger signal generating unit 102 to generate a trigger signal at the point in time when the event of the specified loop iteration is detected. In other words, by setting the register flag of the trigger signal generating unit 102 corresponding to the event of the specified loop iteration, the dump control unit 103 sets to valid or invalid the setting for adopting the detection of the specified loop iteration as the trigger signal (S311).

Next, the dump control unit 103 checks with the accepting unit 180 whether or not there is an instruction to specify the specified interrupt signal as an event (S312). In the case where there is, in the accepting unit 180, an instruction for specifying the specified interrupt signal as an event (Yes in S312), the dump control unit 103 sets the trigger signal generating unit 102 to generate a trigger signal at the point in time when the event of the specified interrupt signal is detected. In other words, by setting the register flag of the trigger signal generating unit 102 corresponding to the event of the specified interrupt signal, the dump control unit 103 sets to valid or invalid the setting for adopting the detection of the specified interrupt signal as the trigger signal (S313).

Next, the dump control unit 103 checks with the accepting unit 180 whether or not there is an instruction to specify the malfunctioning of the bus as an event (S314). In the case where there is, in the accepting unit 180, an instruction for specifying the malfunctioning of a bus as an event (Yes in S314), the dump control unit 103 sets the trigger signal generating unit 102 to generate a trigger signal at the point in time when the event of the malfunctioning of the bus is detected. In other words, by setting the register flag of the trigger signal generating unit 102 corresponding to the event of the malfunctioning of the bus, the dump control unit 103 sets to valid or invalid the setting for adopting the detection of the malfunctioning of the bus as the trigger signal (S315).

As described above, the event for causing the generation of a trigger signal is specified by a user operation via the accepting unit 180 and, in accordance with the accepting unit 180, the trigger signal generating unit 102 can determine the generation of a trigger signal corresponding to the event detection specified by the user.

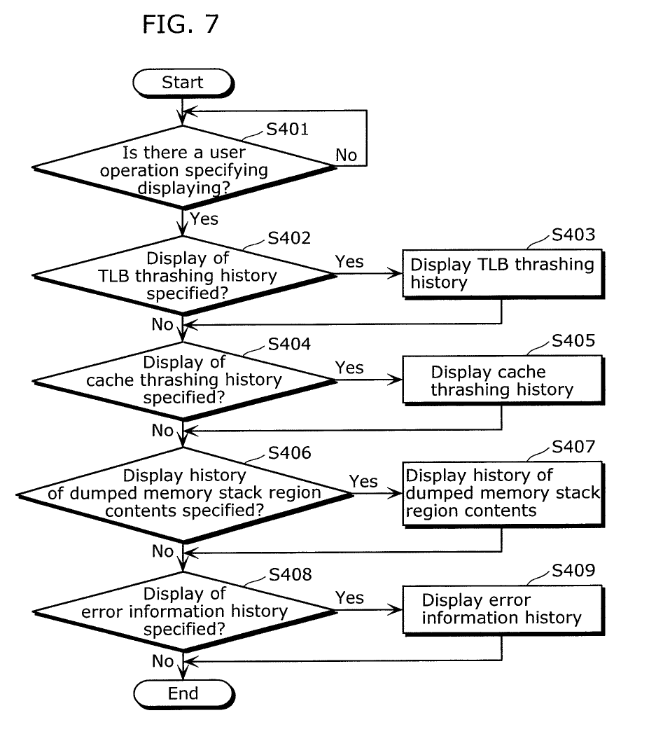

FIG. 7 is a flowchart describing the process in displaying the debugging information in the embodiment of the present invention.

First, the dump control unit 103 checks with the accepting unit 180 whether or not there is a user operation specifying displaying (S401).

Here, displaying refers to the displaying on the display device 2b such as a monitor, shown in FIG. 1 or FIG. 2.

Next, the dump control unit 103 checks with the accepting unit 180 whether or not there is an instruction specifying the display of the TLB thrashing history (S402). In the case where there is, in the accepting unit 180, an instruction specifying the display of the TLB thrashing history (Yes in S402), the dump control unit 103 issues an instruction for sending, to the display device, the TLB thrashing history among the dump information accumulated by the dump accumulating unit 171 or the nonvolatile memory 173. The display device displays the sent TLB thrashing history (S403).

Next, the dump control unit 103 checks with the accepting unit 180 whether or not there is an instruction specifying the display of the cache thrashing history (S404). In the case where there is, in the accepting unit 180, an instruction specifying the display of the cache thrashing history (Yes in S404), the dump control unit 103 issues an instruction for sending, to the display device, the cache thrashing history among the dump information accumulated by the dump accumulating unit 171 or the nonvolatile memory 173. The display device displays the sent cache thrashing history (S405).

Next, the dump control unit 103 checks with the accepting unit 180 whether or not there is an instruction specifying the display of the history of the dumped external memory 130 stack region contents (S406). In the case where there is, in the accepting unit 180, an instruction specifying the display of the history of the dumped external memory 130 stack region contents (Yes in S406), the dump control unit 103 issues an instruction for sending, to the display device, the history of the dumped external memory 130 stack region contents, among the dump information accumulated by the dump accumulating unit 171 or the nonvolatile memory 173. The display device displays the sent history of the dumped external memory 130 stack region contents (S407).

Next, the dump control unit 103 checks with the accepting unit 180 whether or not there is an instruction specifying the display of error information history (S408). In the case where there is, in the accepting unit 180, an instruction specifying the display of the error information history (Yes in S408), the dump control unit 103 issues an instruction for sending, to the display device, the error information history among the dump information accumulated by the dump accumulating unit 171 or the nonvolatile memory 173. The display device displays the sent error information history (S409).

As described above, the contents to be the displayed on the display device 2b is specified by a user operation via the accepting unit 180 and, in accordance with the accepting unit 180, the dump control unit 103 can cause the display device 2b to display the dump information corresponding to the specified display contents.

With the above-described configuration, in the one program execution in which the execution of the program is stopped, it is possible to obtain stack region contents along the time-series, as debugging information. With this, it is possible to check along the time-series, from the stack information, for example, the operation history of a program or the argument of a function, and the value of a local variable of a program, in the case where plural functions are executed successively, and thus it is possible to analyze why the program malfunctions.

Furthermore, in the one program execution up to the stopping of the execution of the program, information indicating the state of the CPU 110 or error information detected by the CPU 110 can be obtained along the time-series, as debugging information. With this, in the case where plural errors occur, it becomes possible to check, all at once, the sequence of the errors and the state of the CPU 110 at the time each error occurred. For example, even in the case where plural errors occur, the history of the system register can be obtained as described above, and the sequence relationships thereof can be stored in one execution. In other words, it is possible to improve program debugging efficiency.

Furthermore, in the one program execution up to the stopping of the execution of the program, the contents of the cache memory 122 or the TLB entry can be obtained along the time-series, as debugging information. With this, the usage of the cache memory 122 or the TLB entry along the time-series of the program execution can be checked all at once. For example, by examining the entry of the cache memory or TLB memory at the time when thrashing in the cache or TLB occurs, it is possible to check, along the time-series, the location at which the high-speed execution of the program is hindered.

Furthermore, in the one program execution up to the stopping of the execution of the program, it is possible to obtain, as debugging information, information on when cache thrashing leading to performance deterioration occurs, and the operating state of the program executing apparatus at such point in time. Furthermore, it is possible to obtain, as debugging information, information on when TLB thrashing leading to performance deterioration occurs, and the operating state of the program executing apparatus at such point in time.

Furthermore, it is possible to obtain, as debugging information, the operating state of the program executing apparatus at the point in time when a specified command is executed, and the operating state of the program executing apparatus at the point in time when the value of a specified program counter is within a specified range. In this manner, by restricting the timing for dumping to the point in time when the value of a specified program counter is within a specified range, reduction of the capacity of the dump information accumulating unit also becomes possible. In other words, in the case where a candidate location for the error is known beforehand through the dumping of debugging information only during the execution of a specified range of a specified command, the usage of the external storage device can be suppressed, and thus it becomes possible to obtain debugging information over a long period of time.

Furthermore, by judging a state of malfunction and dumping debugging information in the case where the currently executed program performs an iteration of an execution of a specified loop portion, it is possible to obtain debugging information at a location of the loop which is considered to be malfunctioning, even in the case where such location is unknown.

Furthermore, it is possible to obtain, as debugging information, the operating state of the program executing apparatus at the point in time when a specified interrupt occurs and before the interrupt is detected by the CPU, or at the point in time when malfunctioning of a bus is detected and before the malfunctioning of the bus is detected by the CPU. For example, by judging a state of malfunction and outputting debugging information in the case where the interrupt control circuit 140 receives specified plural interrupts, it becomes possible to judge malfunctioning, other than from the situation in which the CPU judges according to the specification of the interrupt control circuit 140, and thus the range of conditions for dumping can be broadened. By dumping debugging information in the case where malfunctioning in the operation of the bus is detected, it becomes possible to output debugging information at a faster stage that is closer to the occurrence of the malfunction, by dumping the information in a state prior to the detection of a bus error by the CPU.

Furthermore, since the information in the nonvolatile memory 173 is not erased even when the power supply to the debugging system is cut-off after obtaining the information indicating the operating state of the program executing apparatus as debugging information, it is possible to save the obtained debugging information. In addition, since the writing of data into the nonvolatile memory 173 from a function block other than the CPU 110 after debugging information is written into the nonvolatile memory 173 can be prevented by the cutting-off of the power supply to the debugging system by the system control circuit 160, it is possible to save the debugging information more reliably.

Furthermore, by setting the trigger generation by the trigger signal generating unit 102, via the accepting unit 180, based on a user operation, to the point in time when a required event preferred by a user occurs, such as when cache thrashing occurs, for example, it is possible to obtain, as debugging information, information indicating the operating state of the program executing apparatus at the time of the occurrence of the required event.

As described above, in the one program execution up to the stopping of the execution of the program, it is possible to obtain, as debugging information, information indicating the operating state of the program executing apparatus at the plural times when the preferred event occurs during program execution.

As described above, in the embodiment of the present invention, in the one program execution up to the stopping of the execution of the program, it is possible to obtain, as debugging information, information indicating the operating state of the program executing apparatus at plural times during program execution. With this, it is possible to implement a debugging system and method capable of efficiently obtaining debugging information, and having good debugging efficiency.

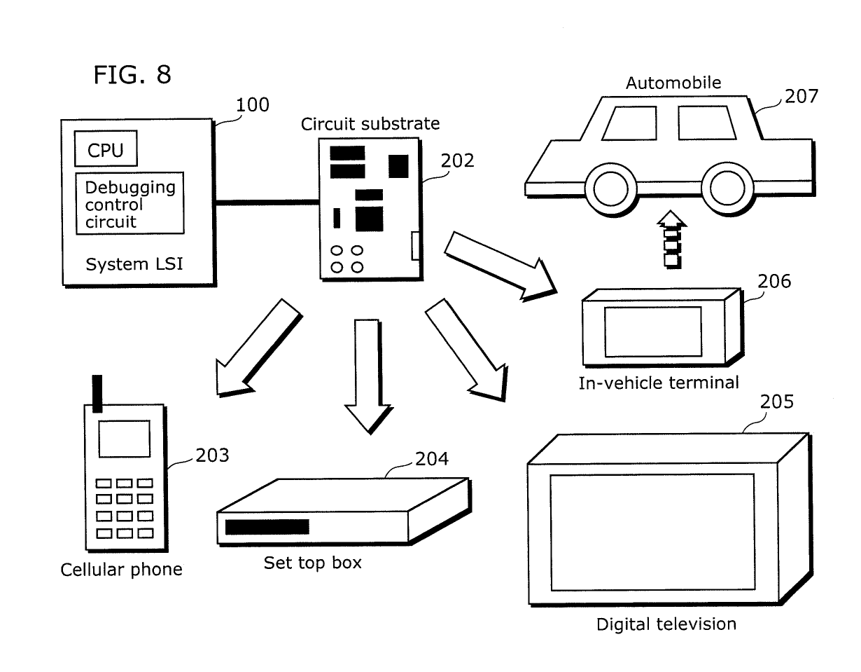

Note that FIG. 8 is a diagram showing, as an example, a circuit substrate 202 of an embedded system using a debugging CPU which is a debug target that can be used in the debugging system 100.

As shown in FIG. 8, it is possible to adopt, as the debug target of the debugging system 100, the circuit substrate 202 of an embedded system using a CPU embedded, for example, in a cellular phone 203, a set top box 204, a digital television 205, and an in-vehicle terminal 206 provided in an automobile 207, and so on.

Furthermore, although in the embodiment of the present invention, the CPU 110, MMU 111, the TLB thrashing detection circuit 112, the cache control circuit 120, the cache thrashing detection circuit 121, the cache memory 122, the external memory 130, and the bus monitoring circuit 150 are included in the program executing apparatus 3 or the program executing apparatus 6 shown in FIG. 1 or FIG. 2, respectively, the configuration is not limited to such. The TLB thrashing detection circuit 112, the cache control circuit 120, the cache thrashing detection circuit 121, the bus monitoring circuit 150, and the debugging control circuit 101 may be included in the program debugging apparatus 2 in FIG. 1 and FIG. 3. Furthermore, the debugging system 100 maybe configured in the same chip, and may store the debug target program in the external memory 130 connected to the embedded system shown in FIG. 8, and execute the program. In other words, the debugging system 100 may include the functions of both the program executing apparatus 6 and the program debugging apparatus 2.

Although the debugging system and method of the present invention has been described thus far based on an embodiment, the present embodiment is not limited to this embodiment. Various modifications to the present embodiments that can be conceived by those skilled in the art, and forms configured by combining constituent elements in different embodiments without departing from the teachings of the present invention are included in the scope of the present invention.

### INDUSTRIAL APPLICABILITY

The present invention can be used in a debugging system and method, and can be used, particularly, in a debugging system and method that performs debugging on an embedded system using a CPU, such as a cellular phone, a digital television, and an in-vehicle terminal.

1. A debugging system which stops execution of a program executed in a program executing apparatus, at a breakpoint, and assists debugging of the program, said debugging system comprising:
a dump control unit configured to dump information indicating an operating state of the program executing apparatus, at plural points in time prior to the stopping of the execution of the program; and
a dump information accumulating unit configured to accumulate the information indicating the operating state of the program executing apparatus dumped by said dump control unit.

2. The debugging system according to claim 1,
wherein the information indicating the operating state of the program executing apparatus includes contents of a stack region of a memory, and
said dump control unit is configured to dump, at the plural points in time, the contents of the stack region of the memory.

3. The debugging system according to claim 1,
wherein the information indicating the operating state of the program executing apparatus includes either information indicating a state of a Central Processing Unit (CPU) or error information detected by the CPU, stored in a system register of the CPU, and
said dump control unit is configured to dump, at the plural points in time, the information indicating either the state of the CPU or the error information detected by the CPU.

4. The debugging system according to claim 1,
wherein the information indicating the operating state of the program executing apparatus includes contents of either a cache memory or a Translation Look-aside Buffer (TLB), and
said dump control unit is configured to dump, at the plural points in time, the contents of either the cache memory or an entry of the TLB.

5. The debugging system according to claim 1,
wherein the information indicating the operating state of the program executing apparatus includes contents of at least one of a memory, a system register of a CPU, a cache memory, and a TLB.

6. The debugging system according to claim 1, further comprising
a trigger signal generating unit configured to generate a trigger signal at the plural points in time,
wherein said dump control unit is configured to dump the information indicating the operating state of the program executing apparatus, when the trigger signal is generated.

7. The debugging system according to claim 6, further comprising
a cache thrashing detecting unit configured to detect an occurrence of thrashing in the cache memory,
wherein said trigger signal generating unit is configured to generate the trigger signal when said cache thrashing detecting unit detects the occurrence of thrashing in the cache memory.

8. The debugging system according to claim 6, further comprising
a TLB thrashing detecting unit configured to detect an occurrence of thrashing in the TLB,
wherein said trigger signal generating unit is configured to generate the trigger signal when said TLB thrashing detecting unit detects the occurrence of thrashing in the TLB.

9. The debugging system according to claim 6, further comprising
a specified command detecting unit configured to detect that a currently executed command is a specified command,
wherein said trigger signal generating unit is configured to generate the trigger signal when said specified command detecting unit detects that the currently executed command is the specified command.

10. The debugging system according to claim 6, further comprising
a within-specified-range detecting unit configured to detect that a value of a program counter in the program executing apparatus is within a specified range,
wherein said trigger signal generating unit is configured to generate the trigger signal when said within-specified-range detecting unit detects that the value of the program counter in the program executing apparatus is within the specified range.

11. The debugging system according to claim 6, further comprising
a loop iteration detecting unit configured to detect an iteration of a specified loop,
wherein said trigger signal generating unit is configured to generate the trigger signal when said loop iteration detecting unit detects the iteration of the specified loop.

12. The debugging system according to claim 6, further comprising
an interrupt signal detecting unit configured to detect a specified interrupt signal,
wherein said trigger signal generating unit is configured to generate the trigger signal when said interrupt signal detecting unit detects the specified interrupt signal.

13. The debugging system according to claim 6, further comprising
a bus malfunction detecting unit configured to detect malfunctioning of a bus,
wherein said trigger signal generating unit is configured to generate the trigger signal when said bus malfunction detecting unit detects the malfunctioning of the bus.

14. The debugging system according to claim 6, further comprising:
a specified command detecting unit configured to detect that a currently executed command is a specified command;
a within-specified-range detecting unit configured to detect that a value of a program counter in the program executing apparatus is within a specified range;
a loop iteration detecting unit configured to detect an iteration of a specified loop;
an interrupt signal detecting unit configured to detect a specified interrupt signal;
a bus malfunction detecting unit configured to detect malfunctioning of a bus; and
an accepting unit configured to accept a user operation,
wherein said trigger signal generating unit is configured (i) to select or not-select, based on the user operation accepted by said accepting unit, each of: a detection result of said specified command detecting unit; a detection result of said within-specified-range detecting unit; a detection result of said loop iteration detecting unit; a detection result of said interrupt signal detecting unit; and a detection result of said bus malfunction detecting unit, and (ii) to generate the trigger signal when said specified command detecting unit, said within-specified-range detecting unit, said loop iteration detecting unit, said interrupt signal detecting unit, and said bus malfunction detecting unit, corresponding to the selected detection result detects the respective detection result.

15. The debugging system according to claim 1, further comprising:
a nonvolatile memory;
a nonvolatile memory control unit configured to control writing into said nonvolatile memory; and
a cut-off control unit configured to cut-off power supply to said dump control unit and said dump information accumulating unit,
wherein said nonvolatile memory control unit is configured to write, into said nonvolatile memory, the information indicating the operating state of the program executing apparatus accumulated in said dump information accumulating unit,
said dump control unit is configured to output a signal for causing termination of an operation, to said termination control unit, after the information indicating the operating state of the program executing apparatus is written into said nonvolatile memory, and
said termination control unit is configured to cut-off the power supply to said dump control unit and said dump information accumulating unit, after said nonvolatile memory control unit writes the information into said nonvolatile memory.

16. A method of stopping execution of a program at a breakpoint and assisting debugging of the program, using a program executing apparatus, said method comprising:
dumping information indicating an operating state of the program executing apparatus, to a dump information accumulation unit, at plural points in time prior to the stopping of the execution of the program,
wherein, in said dumping, the information is accumulated in the dump information accumulating unit.

17. A computer program product for stopping execution of a program executed in a program executing apparatus, at a breakpoint, and assisting debugging of the program, said computer program product, when loaded into a computer, allowing the computer to execute:
dumping information indicating an operating state of the program executing apparatus, to a dump information accumulation unit, at plural points in time prior to the stopping of the execution of the program,
wherein, in said dumping, the information is accumulated in the dump information accumulating unit.

18. The debugging system according to claim 5, further comprising
a trigger signal generating unit configured to generate a trigger signal at the plural points in time,
wherein said dump control unit is configured to dump the information indicating the operating state of the program executing apparatus, when the trigger signal is generated.
